(19) United States
(12) Patent Application Publication
(10) Pub. No.: US 2003/0016829 A1
(43) Pub. Date: Jan. 23, 2003

(54) System and method for protecting content data

(75) Inventor: Chang-nam Chu, Seoul (KR)

Correspondence Address: SUGHRUE MION, PLLC, 2100 Pennsylvania Avenue, NW, Washington, DC, 20037-3213, US

(73) Assignee: SAMSUNG ELECTRONICS CO. LTD.

(21) Appl. No.: 10/170,202

(22) Filed: Jun. 13, 2002

(30) Foreign Application Priority Data
Jun. 15, 2001 (KR) 2001-33909

(51) Int. Cl. G06F 12/14

(52) U.S. Cl. 380/281; 713/193

(57) ABSTRACT

A system and method for protecting content data are provided. In the system and method, by encrypting content data so that the content data is distributed with user privileges managed as the copyright holder wants, illegal copying is prevented and user privileges are managed according to predetermined regulations. The method for providing content data comprising the steps of (a) receiving user keys generated by a combination of unique information assigned uniquely to a user; and (b) encrypting the content data using the user keys and a predetermined encryption algorithm, and transmitting the encrypted content data to a user system. According to the system and method, by encrypting content data so that the content data is distributed with the user privileges managed as the copyright holder wants, illegal copying is prevented and user privileges are managed according to predetermined regulations. Also, because user keys are encrypted using the HUK, the possible exposure of user keys is prevented and content data can be distributed as the copyright holder wants using the DRM database.

### BACKGROUND OF THE INVENTION

1. Field of the Invention

The present invention relates to an encryption system and method, and more particularly, to a system and method for protecting content data, in which by encrypting content data so that the content data is distributed with the user privileges managed as the copyright holder wants, illegal copying is prevented and user privileges are managed according to predetermined regulations.

2. Description of the Related Art

As digital content data is easily distributed in line with the development of the Internet, more digital content data is illegally copied without copyright protection. In particular, illegal person-to-person distribution between individuals infringing copyrights are increasing.

FIG. 1 is a block diagram of the prior art content protection system, in which a main server 10 receives member registration information from a user system 10, generates a user key for decrypting the encrypted content data, and transmits the user key to the user system 10 through a Content Service Provider (CSP) server 11. In response to the user's request for content data, the CSP server 11 requests the main server 10 for a user key, receives the user key, encrypts the content data, and transmits the content data to the user system 10. The user system 12 stores the user key transmitted from the main server 10, requests the CSP server 11 for content data, decrypts encrypted content data transmitted from the CSP server 11, and reproduces and stores the content data. Also, the user system 12 transmits the content data to a device 13, for example, an MP3. The device receives the user key and encrypted content data from the user system 12 and decrypts and reproduces the content data.

The prior art content protection system simply generates a unique key for an individual Internet user when the user registers as a member, and stores the key in the user system 12. When the user buys content data, the content protection system identifies the user by an, ID and password, encrypts the content data through an encryption algorithm with the unique key of the user. and downloads the content data to the user system 12. In the user system 12, a program for reproducing the content data reads the stored unique key when reproducing the content data, decodes the content data, and reproduces the content data. The device 13 which communicates with the user system 12 also stores the unique key, and using the unique key, decodes the downloaded content data and reproduces the content data.

In the prior art content protection system, illegal use of content data cannot be thoroughly prevented. First, when a user ID or password is exposed, a third person receives the unique key of the user, and reproduces the content data of the user. If the already downloaded user key is transferred to a third person with the content data, the third person can also reproduce the content data. Also, since the prior art content protection system uses a simple encryption method, the holder of the copyright for the content data cannot manage user privileges of the content data as the copyright holder wants.

### SUMMARY OF THE INVENTION

To solve the above problems, it is a first objective of the present invention to provide a system for protecting content data, in which by encrypting content data, which is legally purchased or obtained, with unique keys and distributing the content data, illegal copying is prevented and only a legal user can use the content data.

It is a second objective of the present invention to provide a method for protecting content data, in which by authenticating user privileges, encrypting content data, which is legally purchased or obtained, with unique keys, and distributing and reproducing the content data, illegal copying is prevented and only legal user can use the content data.

To accomplish the first objective of the present invention, there is provided an apparatus for transmitting content data comprising a key information receiving means for receiving user keys from a user, the user keys generated by a combination of information items uniquely assigned to the user; and a content data encryption means for encrypting content data using the user keys and a predetermined encryption algorithm, and transmitting the content data to the user system.

To accomplish the first objective of the present invention, there is provided an apparatus for decoding encrypted content data in a user system which receives the encrypted content data provided by a content data providing means, the apparatus comprising a key reading means for reading user keys generated by a combination of information items unique to the user system; and a content data decoding means for decoding the received content data with the user keys read from the key reading means, and reproducing the content data.

To accomplish the first objective of the present invention, there is provided an apparatus for transmitting content data from a user system storing the content data to a portable device, the apparatus comprising a key generating means for generating a predetermined common key through mutual authentication between the user system and the portable device; and a content data encryption means for re-encrypting the content data with the common key and transmitting the content data to the portable device.

To accomplish the first objective of the present invention, there is provided an apparatus for decoding content data transmitted from a user system to a portable device, the apparatus comprising a key reading means for reading a common key generated by authentication of the user system and the portable device; and a content data decoding means for decoding the received content data with the common key and reproducing the content data.

To accomplish the second objective of the present invention, there is provided a method for providing content data comprising the steps of (a) receiving user keys generated by a combination of unique information assigned uniquely to a user; and (b) encrypting the content data using the user keys and a predetermined encryption algorithm, and transmitting the encrypted content data to a user system.

To accomplish the second objective of the present invention, there is provided a method for decoding encrypted content data in a user system which receives the encrypted content data provided by a content data providing means, the method comprising the steps of (a) reading user keys which are generated by a combination of information items unique to the user; and (b) decoding the received content data using the user keys, and reproducing the content data.

To accomplish the second objective of the present invention, there is provided a method for decoding in a portable device content data which is transmitted from a user system, the method comprising the steps of (a) reading a common key generated by authentication with the user system; and (b) reproducing the received content data using the common key.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram of the structure of a prior art content data protection system;

FIG. 2 is a block diagram of the structure of a content data protection system according to the present invention

FIG. 3 is a detailed diagram of FIG. 2;

FIG. 4 is a detailed diagram of an encryption unit in a content service provider (CSP) server of FIG. 3;

FIG. 5 is a detailed diagram of a content reproducing unit of a client system of FIG. 3;

FIG. 6 is a diagram of an encryption format of content data in a Content Service Provider (CSP) server;

FIG. 7 is a diagram of a Digital Right Management (DRM) database format established in the client system of FIG. 2;

FIG. 8 is a flowchart of the operation of a method for protecting content data;

FIG. 9 is a flowchart of the operation of a method for authenticating user privileges according to the present invention;

FIG. 10 is a flowchart of the operation of encryption and transmission of content data according to the present invention;

FIG. 11 is a flowchart of the operation of a method for encrypting content data in FIG. 10;

FIG. 12 is a flowchart of the operation of a method for decrypting and reproducing content data according to the present invention;

FIG. 13 is a flowchart of the operation of a method for downloading content data according to the present invention; and

FIG. 14 is a flowchart of the operation of a method for uploading content data.

### DESCRIPTION OF THE PREFERRED EMBODIMENTS

In the present invention, four keys are used in encrypting and decrypting content data, which will now be explained before a detailed explanation of the present invention.

First, a user key is generated in a main server. The encryption method of the present invention adopts an asymmetrical encryption.

The main server generates a public key for encrypting content data and a private key for decrypting encrypted content data.

The public key is transmitted to a content providing server for encrypting content data, while the private key is transmitted to a user system for decrypting encrypted content data. The user key is generated in the main server, using unique information of a registered user, for example, an ID, password, resident registration number, etc.

Second, a Host Unit Key (HUK) is generated in the user system. The HUK is generated using unique information of the user system, and each user system has a different HUK. The HUK is generated by combining a hard disc serial number or O/S level information inside the user system. The HUK is transmitted to the main server, and the main server encrypts the private key with the HUK, and then transmits the private key to the user system. Also, a portable device generates its own unique key and uses the key in encrypting and decrypting content data.

Third, a Content Encryption Key (CEK) is generated in the content providing server. The CEK is generated to encrypt content data to be provided to the user. The content data requested by the user is encrypted with the CEK and transmitted to the user system.

Fourth, a channel key which is commonly shared with the portable device is generated in the user system. When the user system transmits content data to the portable device, content data is encrypted with the channel key, and the portable device decrypts the encrypted content data transmitted from the user system.

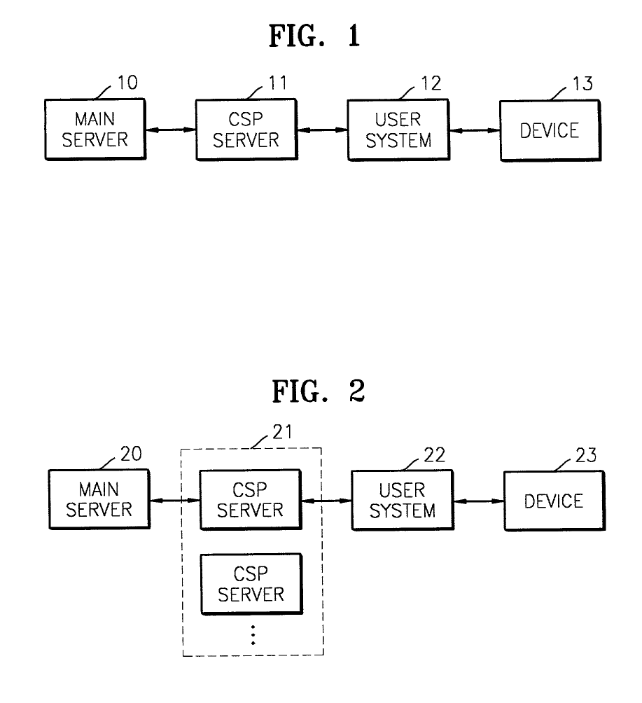

Referring to FIGS. 1 through 7, a system for protecting content data will now be explained.

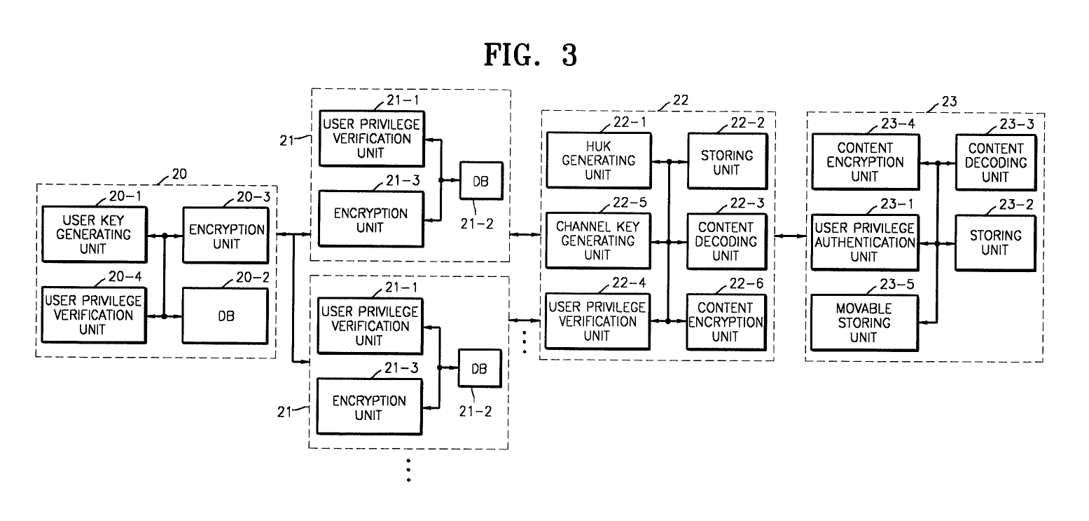

FIG. 2 is a block diagram of the structure of a system for protecting content data according to the present invention. The system for protecting content data includes a main server 20, content providing servers 21, a user system 22, and a portable device 23.

The main server 20 is a Key Management Server (KMS), and is referred to as a management means in the claims of the present application. The main server 20 verifies user privileges, generates user keys, encrypts the user keys, and manages the user keys.

Referring to FIG. 3, the user key generating unit 20-1 generates user keys (a public key and a private key) for encrypting and decrypting content data, using registered member information (ID and password) and unique information which is assigned uniquely to the user, for example, a resident registration number. A database 20-2 stores information on the user registered as a member and the user keys. An encryption unit 20-3 receives an HUK from the user system 22, and encrypts the private key of the generated user keys with the HUK. The encrypted private key is also stored in the database 20-2. In order to transmit the user keys in response to a request from the content providing server 21, a user privilege verification unit 21-1 verifies user privileges of the user, and only when the privileges are permitted, transmits the public key to the content providing server 21. The user keys are separately managed in the main server 20, so whichever content providing server 21 the user receives the content data from, the user can encrypt the content data with the same user keys. Though each content providing server 21 has a different ID or password of the user, the same user keys are transmitted to all content providing servers 21 because the main server 20 generates user keys using the HUK.

The content providing server 21 receives the user keys transmitted from the main server 20 in response to the user's request for the content data, encrypts the predetermined content data, and transmits the content data.

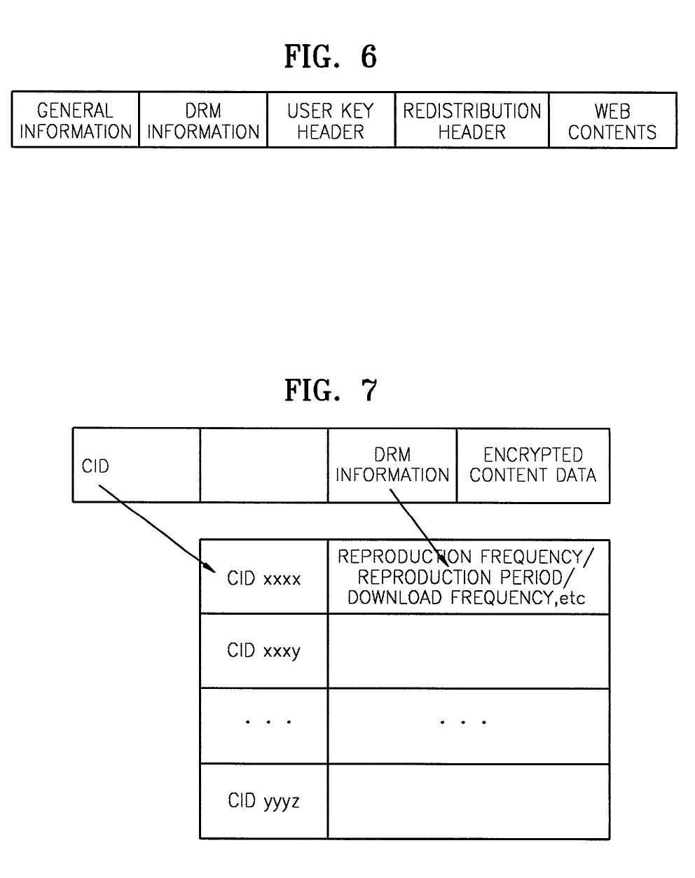

Referring to the detailed diagram of the content providing server of FIG. 3, the user privilege verification unit 21-1 verifies proper information (ID, password, or resident registration number) input by the user. The user privilege verification unit 21-1 access the main server 20, transmits user's unique information, and if the privileges are permitted, receives the public for encrypting the content data. The database 21-2 stores user information and the received public key, and also stores the content information which is encrypted later. An encryption unit 21-3 encrypts the content data in the format shown in FIG. 6, and transmits the encrypted content data to user system 22. Referring to FIG. 6, the content data encryption format includes a header, which is formed with general information, Digital Right Management (DRM) information, a user key header, and a redistribution header, and the content data. In the general information area, the ID of the content data to be transmitted is recorded. In the DRM information area, regulations for using the content data of the copyright holder are written. The regulations includes the permitted frequency and period of reproducing the content data, and the number of devices which are allowed to transmit the content data. In the user key header area, a CEK for encrypting the content data is recorded. FIG. 4 is a detailed diagram of the encryption unit 21-3. A CEK generating unit 21-31 randomly generates a CEK for encrypting the content data. The CEK is recorded in the user key header area. A content encryption unit 21-32 encrypts the content data using the content data, which is requested by the user, using the CEK. The content encryption unit 21-32 encrypts the CEK and an encryption algorithm (for example, SNAKE). A DRM information generation unit 21-32 generates and specifies the DRM information, described above, and records the DRM information in the DRM information area of the header. A header encryption unit 21-34 encrypts general information, DRM information, the user key header, and the redistribution header of the content data to be encrypted. The header is encrypted by the public key transmitted from the main server 20 and an ECC. A data transmitting unit 21-35 transmits the encrypted content data and header to the user system 22.

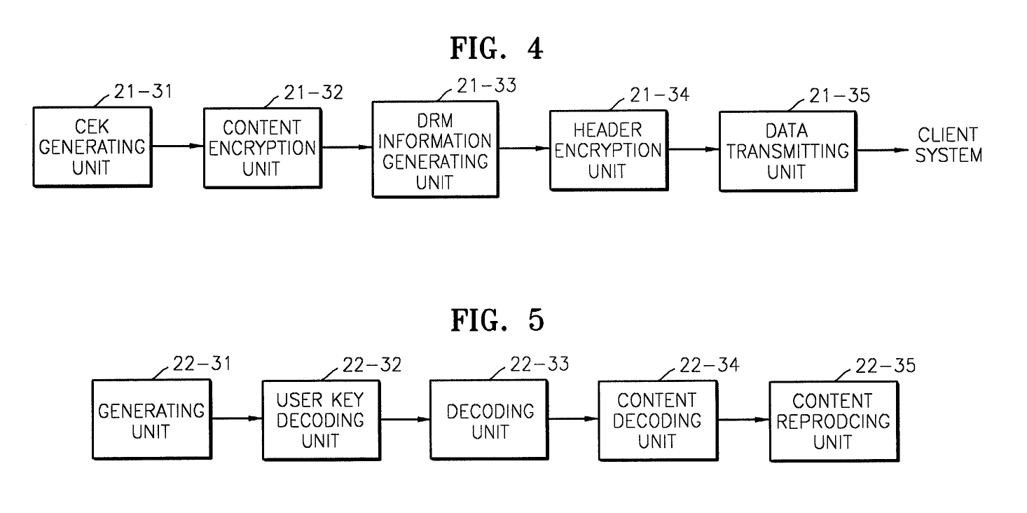

The user system 22 manages and reproduces the received content data, and transmits the content data to the portable device 23. Referring to the detailed diagram of the user system 22 of FIG. 3, an the HUK generating unit 22-1 generates an HUK using the unique information of the user system, stores the HUK in the storing unit 22-2, and transmits the HUK to the main server 20. A content decoding unit 22-3 decodes the content data transmitted from the content providing server 21 and reproduces the content data. Referring to FIG. 5, the detailed diagram of the content decoding unit 22-3, a DRM database generating unit 22-31 generates a DRM database in a safe place of the storing unit 22-2 when the content data is reproduced first time. The DRM database is generated in the format shown in FIG. 7, and includes a Content ID (CID), DRM information, and encrypted content data. In the CID, the unique ID of the content data is recorded. The CID is the unique ID of the content data, and is obtained by extracting digital data items at a predetermined interval in the pure content data before encryption. In DRAM information, content data management information is recorded. Content data management information includes the permitted frequency and period of reproducing the content data, and the permitted frequency of downloading the content data to the portable device 23. In the encrypted content data, the encrypted content data transmitted from the content providing server 21 is recorded. The DRAM database is updated whenever the content data is used. When the user wants to reproduce the content data, the user registers in the DRAM database, using the CID, and determines whether or not to use the content data, considering the content management information prepared by the copyright holder. After the user uses the content data, the DRM database is updated. The DRAM database should be generated in one user system 22. When another user system (not shown) is used, though the content data is copied to the other user system through backup/restore, whether or not to use the content data is determined in the same DRM database, and there are restrictions. A user key decoding unit 22-32 extracts the pure private key by decoding the private key transmitted from the main server 20, using the HUK stored in the storing unit 22-2. A CEK decoding unit 22-33 extracts the CEK by decrypting the header encrypted with the ECC using the pure private key. A content decoding unit 22-34 decodes the content data encrypted with a unique algorithm (for example, SNAKE), using the CEK. A content reproducing unit 22-35 reproduces the decoded content data. After the content data is reproduced, the DRM database is updated. When the user system 22 transmits the content data to the portable device 23, it is determined whether or not the content data can be downloaded to the DRM database using the CID. If the content database can be downloaded, the user privilege verification unit 22-4 opens a Secure Authenticate Channel (SAC) by communicating with the portable device 23 and performs mutual authentication. If the authentication is done, a channel key is generated and commonly shared. The content encryption unit 22-6 re-encrypts the header of the decoded content data with the channel key and transmits the content data to the portable device 23.

The portable device 23 reproduces the content data transmitted from the user system 22, stores the content data in the storing unit 23-3, or transmits the content data to the movable storing unit 23-5. The portable device 23 includes all kinds of digital devices which reproduce or open the digital content data. Referring to the detailed diagram of the portable device of FIG. 3, the user privilege authentication unit 23-1 generates and shares a channel key, through the mutual authentication with the user system 22. The content decoding unit 23-3 decodes the content data using the header in the content data. The content encryption unit 23-4 re-encrypts the header, using a unique key generated by a combination of information items unique to the portable device 23, which is referred to as portable device (PD) binding. In reproducing the content data, the content decoding unit 23-3 extracts the CEK by decoding the header using the unique key of the portable device 23, decodes the content data using the extracted CEK, and reproduces the content data. In transmitting the content data to the movable storing unit 23-5, the header is decoded using the unique key of the portable device 23, and re-encrypted by a unique key generated in the movable storing unit 23-5, and stored. This is referred to as Portable Memory (PM) binding. Information on whether or not the content data is transmitted to the portable device 23 (the frequency of downloading content data to the portable device) is updated in the DRM database of the user system 22. When the content data is uploaded from the portable device 23, mutual authentication is also performed through the user privilege authentication unit 23-1, and the fact that the content data is to be uploaded to the user system 22 is notified to the user system. The portable device 23 deletes the content data stored in the storing unit 23-3 or the movable storing unit 23-5, and the user system 22 updates information on whether or not the content is uploaded in the DRM database.

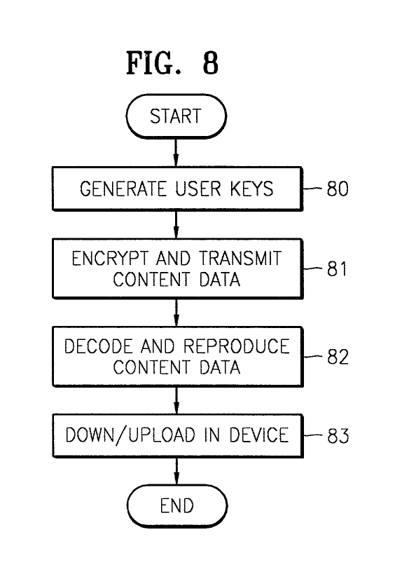

Referring to FIGS. 8 through 14, the present invention will now be explained in detail.

FIG. 8 is a flowchart of the operation of a method for protecting content data. The method includes generating user keys in step 80, encrypting and transmitting the content data in step 81, decrypting and reproducing the content data in step 82, downloading the content data to the portable device and uploading the content data from the portable device in step 83.

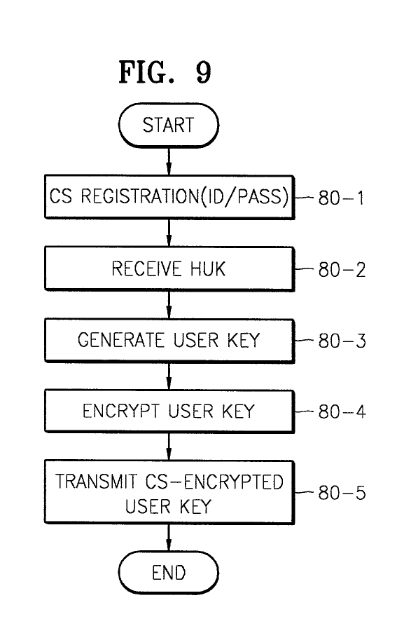

The step 80 for generating user keys is performed in the main server 20 as shown in FIG. 9. First, unique information of the user (for example, an ID, password, resident registration number, etc.) is received and member registration is performed in step 80-1. The HUK, which is generated with unique information of the user system 22 which is used by the registered user, and is transmitted from the user, is received in step 80-2. User keys (a public key and a private key) for encrypting and decrypting the content data are generated using unique information of the user, and stored with the HUK in step 80-3. The private key in the user keys is encrypted with the HUK so that the private key is transmitted to the user system 22 in step 80-4. The encrypted private key is transmitted to the user system 22 in step 80-5. In the present invention, the user keys are generated using unique information assigned uniquely to the user, the user keys themselves may be transmitted to the content providing server 21 and the user system 22, or the user keys may be transmitted to the user system 22 after being encrypted with the HUK.

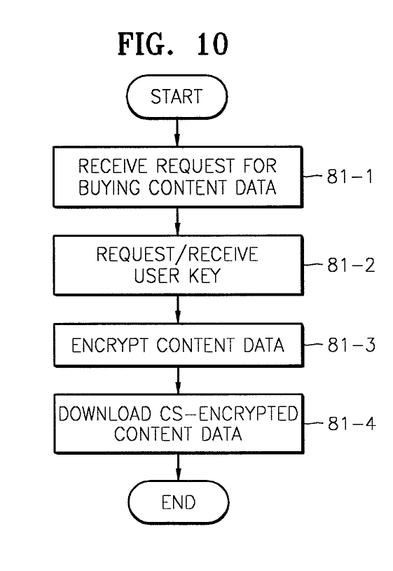

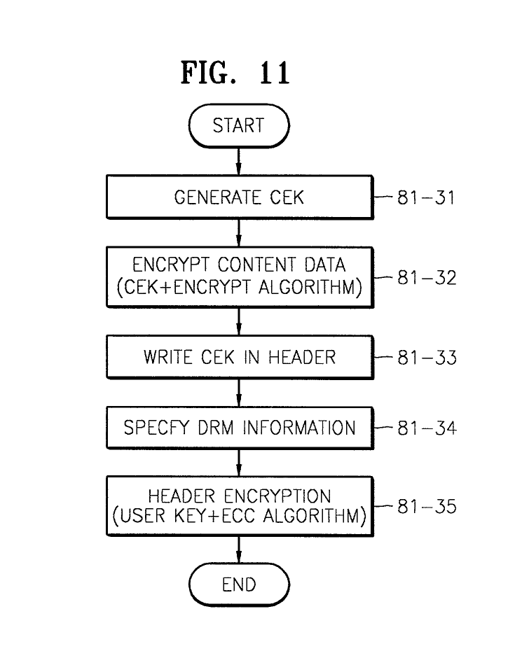

The step 81 for encrypting and transmitting the content data, which is shown in FIGS. 10 and 11, is performed in the content providing server 21.

A signal for requesting purchase of content data from the user is received in step 81-1. User information is transmitted to the main server 20, and if authentication is done, the public key is received in step 81-2. Using the public key transmitted from the main server 20, the content data is encrypted in step 81-3. The encrypted content data is transmitted to the user system 22. FIG. 11 is a flowchart of the operation of a method for encrypting content data. The content data is encrypted as the format of FIG. 3, which includes a header formed with general information, DRM information, a user key header, and a redistribution header, and the content data. In the general information area, the ID of the content data to be transmitted is recorded. In the DRM information area, regulations for using the content data of the copyright holder are written. The regulations includes the permitted frequency and period of reproducing the content data, and the number of devices which are allowed to transmit the content data. In the user key header area, a CEK for encrypting the content data is recorded. A CEK is randomly generated to encrypt the content data in step 81-31. The content data is encrypted using the CEK and an encryption algorithm (for example, SNAKE) in step 81-32. The CEK is recorded in the header area in step 81-33. DRM information is specified in step 81-34. DRM information, described above, is generated, specified, and then recorded in the DRM information area. The header formed with the general information area, the DRM information area, the user key header area, and the redistribution header area, is encrypted using the public key transmitted by the main server 20, and an ECC encryption algorithm, and transmitted to the user system 22.

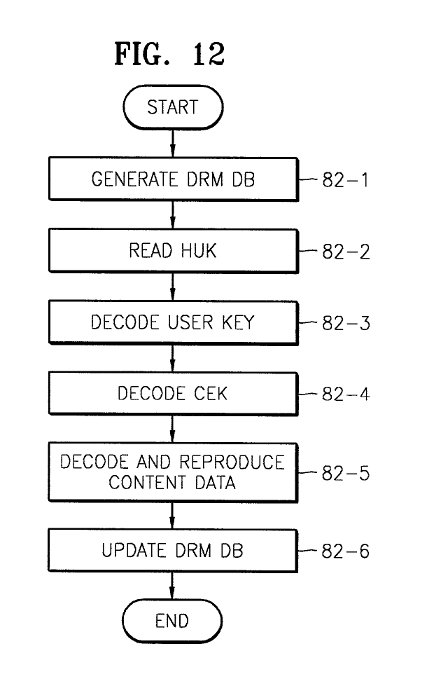

The step 83 for decrypting and reproducing the content data of FIG. 12 is performed in the user system 22. When the content data is reproduced first time, a DRM database is generated in a safe place (HDD) of the user system. The DRM database is generated in the format shown in FIG. 7, and includes a Content ID (CID), DRM information, and encrypted content data. In the CID, the unique ID of the content data is recorded. The CID is the unique ID of the content data, and is obtained by extracting digital data items at a predetermined interval in the pure content data before encryption. In DRAM information, content data management information is recorded. Content data management information includes the permitted frequency and period of reproducing the content data, and the permitted frequency of downloading the content data to the portable device 23. In the encrypted content data, the encrypted content data transmitted from the content providing server 21 is recorded. The HUK is read after generating the DRM database in step 82-2. The private key which is encrypted using the HUK transmitted from the main server 20 is decoded using the HUK and extracts the pure private key in step 82-3. Using the pure private key, the header encrypted using the ECC algorithm is decoded and the CEK is extracted in step 82-4. Using the CEK, the content data encrypted using a unique encryption algorithm (for example, SNAKE) is decoded and reproduced in step 82-5. After reproducing the content data, the DRM database is updated in step 82-6.

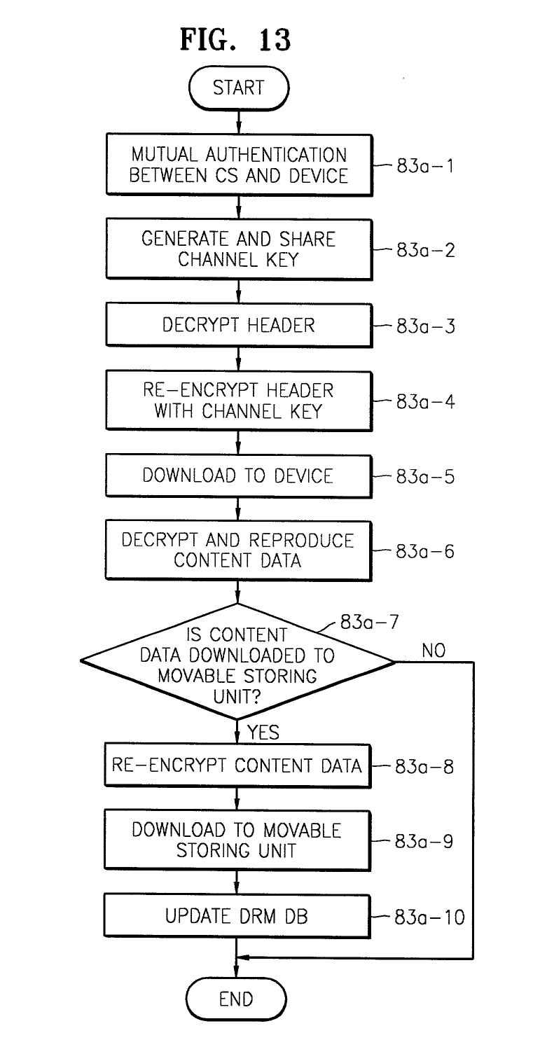

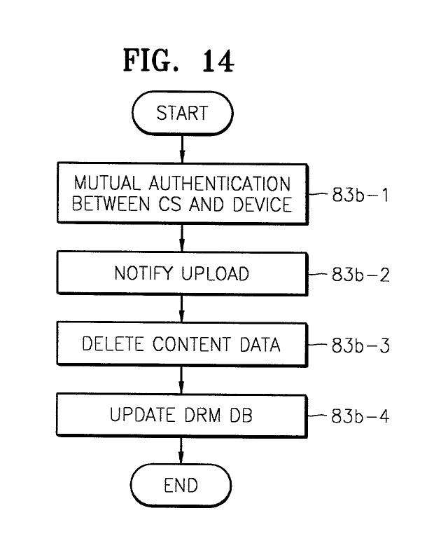

The step 83 for downloading the content data to the portable device and uploading the content data from the portable device of FIGS. 13 and 14 is performed in the user system 22 and the portable device 23. FIG. 13 is the step for downloading and FIG. 14 is the step for uploading. In FIG. 13, steps 83a-1 through 83a-5 are performed in the user system 22, and the remaining steps are performed in the portable device 23. In order to download the content data to the portable device 23, the CID in the DRM database is first searched for and it is determined whether or not the content data can be downloaded. If the content data can be downloaded, the user system 22 performs mutual authentication by opening a Secure Authentication Channel (SAC) with the portable device 23 in step 83a-1. If the mutual authentication is done, a channel key is generated and shared with the portable device 23 in step 83a-2. Using the HUK, the user system 22 extracts the pure private key and decodes the header in step 83a-3. The decoded header is re-encrypted using the channel key in step 83a-4. The re-encrypted header and content data are downloaded to the portable device in step 83a-5. The downloaded content data is decoded and reproduced in the portable device 23. After decoding the header of the content data encrypted with the channel key, the portable device 23 re-encrypts the header using a unique key generated by a combination of unique information of the portable device 23, and stores the header. This is referred to as Portable Device (PD) binding. In reproducing the content data, the user system 22 decodes the header with its unique key so as to extract the CEK, and using the CEK, decodes the content data and reproduces the content data. In downloading the content data to the movable storing unit in step 83a-6, the content data is re-encrypted in step 83a-7. After decoding the header using its unique key, the portable device 23 re-encrypts the header using a unique key generated in the movable storing unit. This is referred to as Portable Memory (PM) binding. The re-encrypted content data is downloaded to the movable storing unit in step 83a-8. In reproducing the content data, the movable storing unit (attached to other portable devices) decodes the header using its unique key, extracts the CEK, decodes the content data using the CEK, and reproduces the content data. If downloading the content data is finished, information on whether or not the content data is downloaded to the device (on the frequency of downloading the content data to the device) is updated in the DRM database of the user system 22. In uploading the content data, the user system 22 and the portable device 23 opens a Secure Authentication Channel (SAC) and performs mutual authentication in step 83b-1. If mutual authentication is done, the portable device 23 notifies that the content data is to be uploaded to the user system 22 in step 83b-2. After the notification, the portable device 23 deletes the content data stored in the internal storing unit or the movable storing unit in step 83b-3. After deleting the content data, the DRM database of the user system 22 is updated in step 83b-4.

The present invention is not restricted to the above-described embodiments and many variations are possible within the spirit and scope of the present invention. The scope of the present invention is not determined by the description but by the accompanying claims.

According to the present invention as described above, by encrypting content data so that the content data is distributed with the user privileges managed as the copyright holder wants, illegal copying is prevented and user privileges are managed as predetermined regulations. Also, because user keys are encrypted using the HUK, the possible exposure of user keys is prevented and content data can be distributed as the copyright holder wants using the DRM database.

What is claimed is

1. A method for providing content data comprising the steps of:
(a) receiving user keys generated by a combination of unique information assigned uniquely to a user; and
(b) encrypting the content data using the user keys and a predetermined encryption algorithm, and transmitting the encrypted content data to a user system.

2. The method of claim 1, wherein the user keys in step (a) are transmitted from the user system or from a key providing system for providing content encryption/decryption keys.

3. The method of claim 1, wherein the user keys in step (a) are encrypted using a unique key generated by a combination of unique information items regarding the user system.

4. The method of claim 1, wherein step (b) further comprises the steps of:
(b-1) generating a header having information indicating the content data
(b-2) generating a predetermined encryption key and encrypting the content data; and
(b-3) encrypting the header using the user keys and a predetermined encryption algorithm.

5. The method of claim 4, wherein the header generated in step (b-1) includes a general information area of the content data, a content data management area having information on the copyright holder's permission to access the content data, an area in which encryption keys are recorded, and an area in which information on redistribution of the content data is recorded.

6. A method for decoding encrypted content data in a user system which receives the encrypted content data provided by a content data providing means, the method comprising the steps of:
(a) reading user keys which are generated by a combination of information items unique to the user; and
(b) decoding the received content data using the user keys, and reproducing the content data.

7. The method of claim 6, wherein the user keys in step (a) are stored in advance in the user system or are transmitted by a key providing system for providing content data encryption/decryption keys.

8. The method of claim 6, wherein the user keys in step (a) are encrypted by a unique key generated by a combination of unique information items indicating the user system.

9. The method of claim 6, wherein step (b) comprises:
(b-1) generating a database of content data management information with permissions from a copyright holder;
(b-2) extracting an encryption key for decoding the content data by decoding a header having information indicating the content data, using the user keys; and
(b-3) decoding the content data by the extracted encryption key, and reproducing the content data.

10. The method of claim 9, wherein the database in step (b-1) stores the ID of the content data and information on usage regulations for the content data.

11. The method of claim 9, wherein the state of the database in step (b-1) is updated whenever the user uses the content data.

12. A method for transmitting content data from a user system storing the content data to a portable device, the method comprising:
(a) generating a predetermined common key through mutual authentication; and
(b) re-encrypting the content data using the common key, and transmitting the content data to the portable device.

13. The method of claim 12, further comprising the step of:
(c) updating the content management information database, which is stored in the user system and has information on permissions from the copyright holder, after the content data is transmitted.

14. The method of claim 12, wherein the common key in step (a) is commonly shared by the user system and the portable device.

15. The method of claim 12, wherein step (b) comprises:
(b-1) extracting user keys generated by a combination of information items unique to the user, and decoding a header having information indicating the content data, using the user keys; and
(b-2) re-encrypting the header using the common key, and transmitting content data to the portable device.

16. The method of claim 15, wherein the user keys in step (b-1) are encrypted using a unique key generated by a combination of information items unique to the user system.

17. A method for decoding in a portable device content data which is transmitted from a user system, the method comprising the steps of:
(a) reading a common key generated by authentication with the user system; and
(b) reproducing the received content data using the common key.

18. The method of claim 17, further comprising the step of:
(c) updating the state of the content data management information database, which is stored in the user system and has information on permission from a copyright holder, after reproducing the content data.

19. The method of claim 17, wherein step (b) comprises the steps of:
(b-1) decoding a header having information indicating the content data, using the common key, and re-encrypting the decoded header, using a unique key generated by a combination of information items unique to the portable device; and
(b-2) extracting an encryption key for decoding the content data, from the decoded header, with the unique key, decoding the content data with the encryption key, and reproducing the content data.

20. The method of claim 17, wherein the content data reproduced in step (b) is encrypted using a unique key generated by a combination of information items unique to a portable memory, and is transmitted.

21. The method of claim 20, the state of the content data management information database, which is stored in the user system and has information on permissions by the copyright holder, is updated after the content data is transmitted.

22. An apparatus for generating user keys comprising:
a key generating means which receives unique information assigned to a user registered as a member, generates user keys for admitting user privileges to use content data, using the received unique information, and transmits the user keys to the user.

23. The apparatus of claim 22, wherein the user keys generated in the key generating means are stored in a content providing means for providing the content data and/or in a user system for reproducing the content data.

24. An apparatus for generating user keys comprising:
a user key generating means which receives unique information assigned to a user registered as a member, and generates user keys for admitting user privileges on content data; and
a key encryption means which receives a unique key generated by a combination of unique information items indicating a user system, encrypts the user keys generated in the key generating means, using the unique key, and transmits the content data to the user.

25. The apparatus of claim 24, wherein the user keys generated in the key generating means are stored in a content providing means for providing the content data and/or in the user system for reproducing the content data.

26. An apparatus for transmitting content data comprising:
a key information receiving means for receiving user keys from a user, the user keys generated by a combination of information items uniquely assigned to the user; and
a content data encryption means for encrypting content data using the user keys and a predetermined encryption algorithm, and transmitting the content data to the user system.

27. The apparatus of claim 26, wherein the key information receiving means receives key information encrypted by a unique key generated by a combination of unique information items indicating the user system.

28. The apparatus of claim 26, wherein the content data encryption means comprises:
a header generating means for generating a header having information indicating the content data;
a content data encryption means for generating a predetermined encryption key and encrypting the content data; and
a header encryption means for encrypting the header, using the user keys and the predetermined encryption algorithm.

29. The apparatus of claim 26, wherein the header includes a general information area of the content data, a content data management area having information on the copyright holder's permission of the content data, an area in which encryption keys are recorded, and an area in which information on redistribution of the content data is recorded.

30. An apparatus for decoding encrypted content data in a user system which receives the encrypted content data provided by a content data providing means, the apparatus comprising:
a key reading means for reading user keys generated by a combination of information items unique to the user system; and
a content data decoding means for decoding the received content data with the user keys read from the key reading means, and reproducing the content data.

31. The apparatus of claim 30, wherein the key reading means reads user keys encrypted by a unique key generated by a combination of unique information items indicating the user system.

32. The apparatus of claim 30, wherein the content data decoding means comprises:
a database generating means for generating a database of content data management information with permissions from a copyright holder;
a key extracting means for extracting an encryption key for decoding the content data by decoding a header having information indicating the content data, using the user keys; and
a content data decoding means for decoding the content data by the extracted encryption key, and reproducing the content data.

33. The apparatus of claim 30, wherein the database stores the ID of the content data and information on usage regulations for the content data.

34. The apparatus of claim 33, wherein the database is updated whenever the user uses the content data.

35. An apparatus for transmitting content data from a user system storing the content data to a portable device, the apparatus comprising:
a key generating means for generating a predetermined common key through mutual authentication between the user system and the portable device; and
a content data encryption means for re-encrypting the content data with the common key and transmitting the content data to the portable device.

36. The apparatus of claim 35, wherein the content management information database, which is stored in the user system and has information on permissions from the copyright holder, is updated after the content data is transmitted.

37. The apparatus of claim 35, wherein the content data encryption means comprises:
a decoding means for extracting user keys generated by a combination of information items unique to the user, and decoding a header having information indicating the content data, using the user keys; and
an encryption means for re-encrypting the header using the common key, and transmitting content data to the portable device.

38. The apparatus of claim 37, wherein the user keys of the decoding means are encrypted using a unique key generated by a combination of information items unique to the user system.

39. An apparatus for decoding content data transmitted from a user system to a portable device, the apparatus comprising:
a key reading means for reading a common key generated by authentication of the user system and the portable device; and
a content data decoding means for decoding the received content data with the common key and reproducing the content data.

40. The apparatus of claim 39, wherein the state of the content data management information database, which is stored in the user system and has information on permissions from a copyright holder, is updated after reproducing the content data.

41. The apparatus of claim 39, wherein the content data decoding means comprises:
an encryption means for decoding a header having information indicating the content data, using the common key, and re-encrypting the decoded header, using a unique key generated by a combination of information items unique to the portable device; and
a decoding means for extracting an encryption key for decoding the content data, from the decoded header, with the unique key, decoding the content data with the encryption key, and reproducing the content data.
